(19) United States
(12) Patent Application Publication
(10) Pub. No.: US 2020/0108394 A1
(43) Pub. Date: Apr. 9, 2020

(54) ELECTROWETTING FORCE DROPLET MANIPULATION

(71) Applicant: Hewlett-Packard Development Company, L.P., Spring, TX (US)

(72) Inventors: Michael W. CUMBIE, Corvallis, OR (US); Viktor SHKOLNIKOV, Palo Alto, CA (US)

(73) Assignee: Hewlett-Packard Development Company, L.P., Spring, TX (US)

(21) Appl. No.: 16/495,127

(22) PCT Filed: Apr. 21, 2017
(86) PCT No.: PCT/US2017/028799

§ 371 Date: Sep. 18, 2019

(51) Int. Cl. B01L 3/00; B01F 13/00

(52) U.S. Cl. CPC B01L 3/502792; B01F 13/0076; B01F 13/0071; B01L 2300/06; B01L 2300/0816; B01L 2300/0645; B01L 2400/0427; B01F 2215/0037

(57) ABSTRACT

One example includes a device that includes an insulator panel, a plurality of electrical inputs, and a plurality of electrodes. The plurality of electrical inputs may be disposed on the insulator panel and individually receive an actuation voltage. The plurality of electrodes may be disposed on the insulator panel and are coupled to the plurality of electrical inputs. Two or more of the plurality of electrodes may be coupled to a single one of the plurality of electrical inputs for each of the plurality of electrical inputs. The plurality of electrodes may be actuated with the actuation voltage individually received at a respective electrical input to create an electric field over associated electrodes to subject a droplet proximate to the associated electrodes actuated with the actuation voltage to an electrowetting force.

### BACKGROUND

Droplet analysis is increasingly becoming used to test small samples (e.g., droplet) of fluid to determine its biological and/or chemical characteristics. Such a droplet may be introduced to a fluid processing chip (e.g., integrated circuit chip) that processes the droplet to determine if the droplet includes various chemicals and/or biological material. In some instances, the droplet may be mixed with one or more other chemicals before analysis by the fluid processing chip.

### BRIEF DESCRIPTION OF THE DRAWINGS

FIG. 1 illustrates an example device for manipulating a droplet.

FIG. 2 illustrates another example device for manipulating the droplet.

FIG. 3 illustrates yet another example device for manipulating a droplet.

FIG. 4 illustrates an example latch access chart to move the droplet in and out of a latch.

FIG. 5 illustrates an example movement of the droplet in and out of the latch.

FIG. 6 illustrates a detailed view of the example electrodes that make up the devices shown in FIGS. 1-3.

FIG. 7 illustrates an input output pad control chart for input pads illustrated in FIG. 3.

### DETAILED DESCRIPTION

The disclosure relates to manipulation of a droplet via an electrowetting force. Examples include a device that may include an insulator panel, a plurality of electrical inputs, and a plurality of electrodes. The plurality of electrical inputs may be disposed on the insulator panel and individually receive an actuation voltage. The plurality of electrodes may be disposed on the insulator panel and are coupled to the plurality of electrical inputs. Two or more of the plurality of electrodes may be coupled to a single one of the plurality of electrical inputs for each of the plurality of electrical inputs. The plurality of electrodes may be actuated with the actuation voltage individually received at a respective electrical input to create an electric field over associated electrodes to subject a droplet proximate to the associated electrodes actuated with the actuation voltage to an electrowetting force. Electrowetting involves modifying the surface tension of a liquid on a solid surface using a voltage. As a result, the actuation voltage may be applied to a single electrical input that creates an electric field over numerous electrodes. In some examples, some of the electrodes may be coupled to input pads that receive samples of fluid, with at least a portion of the samples of fluid being subject to an electrowetting force with the plurality of electrodes. In other examples, the droplet may be moved to a sensor for analysis.

The device may allow for a reduction in a number of electrical inputs into a chip that includes the device, providing for improved scaling for large number of parallel operations, smaller overall chip area, a simpler control system, and higher reliability. The device may employ a reduced number of electrical inputs to control electric fields over a plurality of electrodes that are utilized to subject a droplet to an electrowetting force. This is in contrast to other devices that employ a one-to-one relationship between a number of electrical inputs and a number of electrodes.

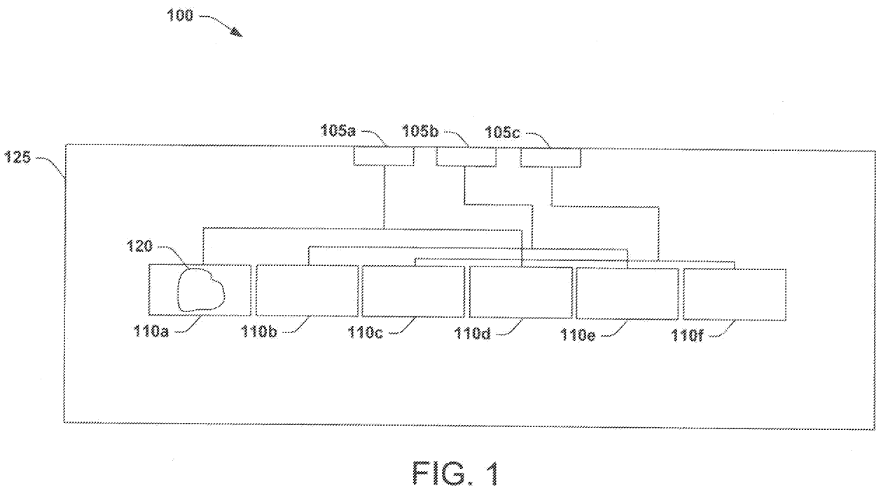

FIG. 1 illustrates an example device 100 for manipulating a droplet 120. The device 100 may include an insulator panel 125. A plurality of electrical inputs 105a-c may be disposed on the insulator panel 125. The plurality of electrical inputs 105a-c may individually receive an actuation voltage.

The device 100 may further include a plurality of electrodes 110a-f disposed on the insulator panel 125. The plurality of electrodes 110a-f may be coupled to the plurality of electrical inputs 105a-c. At least two of the plurality of electrodes 110a-110f may be coupled to a single one of the plurality of electrical inputs 105a-c, respectively. The plurality of electrodes 110a-f may be actuated with the actuation voltage individually received at the plurality of electrical inputs 105a-c to create an electric field over the plurality of electrodes 110a-f actuated with the actuation voltage to subject a droplet 120 proximate to at least one of the plurality of electrodes 110a-f actuated with the actuation voltage to an electrowetting force.

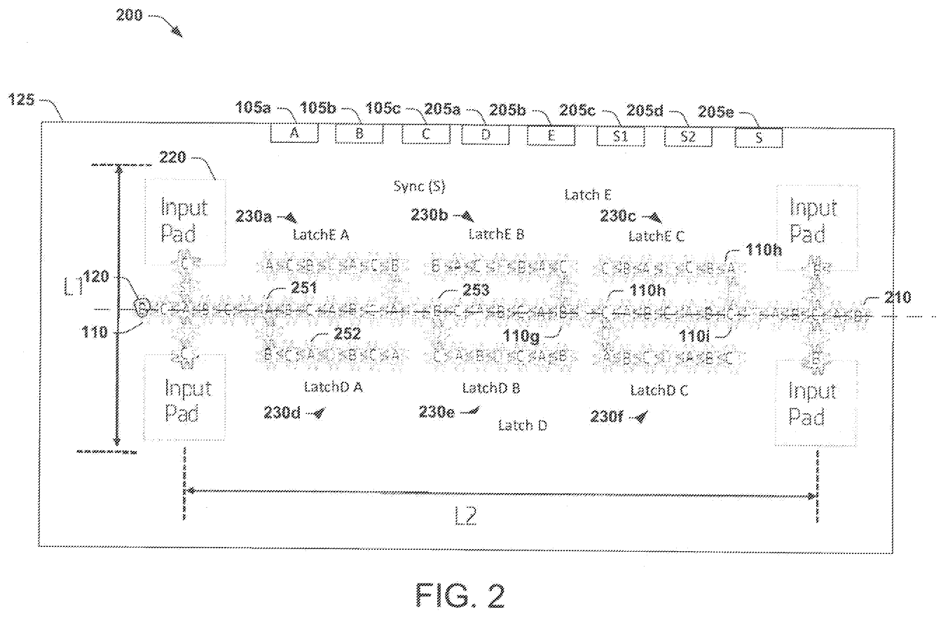

FIG. 2 illustrates another example device 200 for manipulating the droplet 120. For simplicity of explanation, a single droplet 120 is illustrated and described. However, multiple droplets may be disposed on the device 200 simultaneously and manipulated. For example, the device 200 may manipulate, that is move, merge, and/or split the droplet 120. In an example, the device 200 may combine these more basic manipulations to implement higher order operations, such as serial dilution by repeatedly moving the droplet 120 that is combined with another fluid back and forth between two electrodes 110. The device 200 may include the components of device 100, such as the electrical inputs 105, the electrodes 110, and the insulator panel 125 (e.g., FR-4 panel). In an example, the electrodes may be 100×100 um in dimension with 25 um interdigitated fingers, and include 1.5 um gaps between them at a 75 um pitch. The electrodes 110 and electrical inputs 105 may be formed on the insulator panel 125 utilizing known foil (e.g., copper foil) overlay and etching techniques (e.g., silk screening, photoengraving, milling, laser resist ablation, etc.). In another example, the insulator panel 125 may be a silicon substrate and the electrodes may be deposited aluminum (e.g., chemical vapor deposition). Thereafter, a thin layer of insulating material (e.g., FR-4 material, silicon, etc.) is overlaid on the electrodes 110 to prevent the electrodes 110 from being wetted and to prevent their signals shorted when a droplet is disposed over two adjacent electrodes 110.

The plurality of electrodes 110 may be disposed approximately in a straight line to form a main passageway 210 of electrodes 110 from one end of the device 200 to another end of the device 200. The droplet 120 may move to any of the electrodes 110 that make up the main passageway 210. The electrodes 110 may include a repeating sequence of three or more electrodes 110 comprised of “A”, “B”, and “C” electrodes. This main passageway 210 of electrodes 110 may include the repeating sequence of “A”, “B”, and “C” electrodes. An actuation voltage may be applied to electrical input 105a. This actuation voltage at electrical input 105a may actuate all of the “A” electrodes to exert an electrowetting force on a droplet 120 proximate to the “A” electrodes. An actuation voltage may be applied to electrical input 105b. This actuation voltage at electrical input 105b actuates all of the “B” electrodes to exert an electrowetting force on a droplet 120 proximate to the “B” electrodes. An actuation voltage may be applied to electrical input 105c. This actuation voltage at electrical input 105c actuates all of the “C” electrodes to exert an electrowetting force on a droplet 120 proximate to the “C” electrodes. Coordinated actuation of the electrodes 110 may result in the droplet 120 moving between electrodes 110, merging with other droplets, splitting of the droplet 120, and mixing of droplets (e.g., mix components within at least two droplets). When the droplet 120 is being moved between two adjacent electrodes 110 (e.g, from the “A” electrode to the “B” electrode), only the electrode that the droplet is being moved to is actuated with the actuation voltage. That is, the electrode 110 that the droplet 120 is being moved from and adjacent to the electrode 110 that the droplet 120 is being moved to is at a second voltage state that is sufficiently lower than the actuation voltage to setup the electrowetting force. In contrast to other devices that employ a one-to-one relationship between a number of electrical inputs and a number of electrodes, the device 200 may include a plurality of electrodes 110 coupled to a single electrical input 105, reducing a number of electrical inputs into a chip that includes the device 200, providing for improved scaling for large number of parallel operations, smaller overall chip area, a simpler control system, and higher reliability.

For example, actuating “A”, “B”, and “C” electrodes sequentially may move the droplet 120 from “A” electrodes to “C” electrode. Repeating this sequence of individually actuating “A”, “B”, and “C” electrodes results in the droplet 120 moving to the right along the main passageway 210 of electrodes 110. Likewise, reversing this sequence by individually actuating “C”, “B”, and “A” electrodes sequentially moves the droplet 120 in a reverse direction along the main passageway 210 to the left.

The main passageway 210 of electrodes 110 from one end of the device 200 to another end of the device 200 may further include “S” sync electrodes. The “S” sync electrodes may all be coupled to electrical input 205e. In an example, electrical inputs 105 and 205 may be 300×300 um in dimension. An actuation voltage applied to electrical input 205e may actuate all of the “S” sync electrodes. The “S” sync electrodes may act as gatekeepers for the droplet 120 in that they control whether the droplet 120 may move from one portion of the plurality of electrodes 110 that make up the main passageway 210 of electrodes 110 to another portion of the plurality of electrodes 110 that make up the main passageway 210 of electrodes 110 unless an actuation voltage is first applied to electrical input 205e to first pull the droplet 120 onto at least one of the “S” sync electrodes. For example, if the droplet 120 is disposed on electrode 110g, the droplet 120 may not move to electrode 110h unless the “S” sync electrodes are actuated by an actuation voltage being applied to electrical input 205e, and vise versa, to pull the droplet 120 onto the “S” electrode between them. Thus, actuation of any of the “A”, “B”, and “C” electrodes between any two de-actuated “S” sync electrodes may result in manipulation of a droplet 120 between such “S” sync electrodes while preventing the droplet 120 from passing a point in the main passageway 210 of electrodes 110 where the “S” sync electrodes are positioned.

The device 200 may further include a plurality of electrodes 110 that form one or more latches 230 that branch off of the main passageway 210. Although the latches 230 are shown as running parallel with the main passageway 210, such an orientation may be utilized to minimize an area utilized to form the device 200. In another example, the latches 230 may be perpendicular to the main passageway 210 or at an angle less than perpendicular to the main passageway 230. In an example, a majority of droplet manipulation (e.g., merging, splitting, mixing) may be performed in the latches 230 to allow the main passageway 210 to remain unblocked. In an example, the device 200 may include six (6) latches 230a-f, with each latch including eight (8) electrodes 110. Actuation of “A”, “B”, and “C” electrodes sequentially may move the droplet 120 into the latches 230. To control entry of the droplet 120 into and out of the latches 230 and within the latch 230, each of the latches 230 may include an electrode 110 designated as an “E” electrode at a point where the latches 230 branch off of the main passageway 210 and an “E” electrode positioned between two strings of three (3) electrodes 110 with the latch 230. The “E” electrodes may all be coupled to electrical input 205b. Thus, an actuation voltage applied to electrical input 205b may actuate all of the “E” electrodes. The “E” electrodes may act as gatekeepers for the droplet 120 in that the droplet 120 may not move from the main passageway 210 of electrodes 110 to the plurality of electrodes 110 that make up the latches 230 unless an actuation voltage is first applied to electrical input 205b to pull the droplet 120 onto the “E” electrodes first. For example, if the droplet 120 is disposed on electrode 110i, the droplet 120 may not move to electrode 110h unless the “E” electrodes are actuated by an actuation voltage being applied to electrical input 205b, and vise versa, to pull the droplet 120 onto the “E” electrode between them. Thus, actuation of any of the “A”, “B”, and “C” electrodes within the latches 230 may result in manipulation of a droplet 120 within the latch 230 while preventing the droplet 120 from moving back to the main passageway 210 until an actuation voltage is first applied to electrical input 205b to pull the droplet 120 onto the “E” electrodes first. Likewise, the droplet 120 may not move from one half of the latch 230 to another half of the latch 230 until an actuation voltage is first applied to electrical input 205b to pull the droplet 120 onto the “E” electrodes first. Other latches 230 may utilize other electrodes 110 to act as gatekeepers. In an example, other latches may utilize “D” electrodes that are all coupled to electrical input 205a, with all of the “D” electrodes being actuated when an actuation voltage is applied to the electrical input 205a.

Latch 230a may be designated as “LatchE A” as latch 230a utilizes an “E” electrode as a gatekeeper and branches off of an “A” electrode from the main passageway 210. Latch 230b may be designated as “LatchE B” as latch 230b utilizes an “E” electrode as a gatekeeper and branches off of a “B” electrode from the main passageway 210. Latch 230c may be designated as “LatchE C” as latch 230c utilizes an “E” electrode as a gatekeeper and branches off of a “C” electrode from the main passageway 210. Thus, although latches 230a-c may utilize an “E” electrode as a gatekeeper, each of the latches 230a-c may be offset with respect to each other in that the combination of electrodes 110 to enter such latches is different. Latch 230d may be designated as “LatchD A” that may utilize an electrode 110 designated as a “D” electrode as a gatekeeper and branches off of an “A” electrode from the main passageway 210. Latch 230e may be designated as “LatchD B” as latch 230e utilizes a “D” electrode as a gatekeeper and branches off of an “B” electrode from the main passageway 210. Latch 230f may be designated as “LatchD C” as latch 230f utilizes a “D” electrode as a gatekeeper and branches off of a “C” electrode from the main passageway 210. Thus, although latches 230d-f may utilize a “D” electrode as a gatekeeper, each of the latches 230d-f may be offset with respect to each other in that the combination of electrodes 110 to enter such latches is different. The device 200 may utilize three electrical inputs 105a-c to control all of the “A”, “B”, and “C” electrodes, two latch inputs 205a and 205b to control the movement of the droplet 120 through all of the latches 230a-f, and n/2 sync electrodes, where n is a number of input pads 220. Thus, for the device 200 that includes four (4) input pads 220, the device may utilize two (2) sync electrodes S1 and S2.

For example, to merge two droplets within the latch 230, two droplets are moved to electrodes 110 speared by an empty electrode 110, for example “A” and “C” electrodes, utilizing either the “D” electrode or the “E” electrode or an “S” electrode. The “B” electrode is actuated with an actuation voltage to merge the two droplets. The merged droplet may be moved back and forth between the “A” and “B” electrodes to mix the merged droplet. The droplet 120 may be split by applying an actuation voltage to electrodes on either side of an electrode 110 on which the droplet 120 is disposed on. For example, if droplet 120 is disposed on the “B” electrode, the droplet 120 may be split by actuating both the “A” and “C” electrodes approximately simultaneously to pull portions of the droplet 120 on both the “A” and “C” electrodes.

The device 200 may further include a plurality of input pads 220. As an example, the device 200 may include four input pads 220. The input pads 220 may be electrodes 110 that exert electrowetting forces on the droplet 120. In an example, each of the input pads 220 may be a point at which a unique fluid is introduced to the device 200. The droplet 120 may be pulled from a larger volume of fluid that is placed on the input pad 220 via an electrode 110 adjacent to the input pad 220. The droplet 120 may be moved to input pad 220 where the droplet 120 may be combined with fluid already on the input pad 220. Nearest input pads 220 on either side of the main passageway 210 may span a distance L1. In an example, L1 may be 1 mm. Input pads 220 on a same side of the main passageway 210 may span a distance L2 from their center point. In an example, L2 may be 2.34 mm. The input pads 220 may include one or more sensors or actuators to analyze or modify the droplet 120 (e.g., a surface for enhanced Raman spectroscopy (SERS), a heater to perform polymerase chain reaction (PCR), etc.). In another example, such one or more sensors or actuators may be coupled to at least one of the latches 230.

Access into and out of input pads 220 on one side of the main passageway 210 may be controlled by electrodes 110 designated as “S1” electrodes. The “C” and “B” electrodes may be disposed between the “S1” electrode and the input pads 220 on the one side of the main passageway 210. Access into and out of input pads 220 on another side of the main passageway 210 may be controlled by electrodes 110 designated as “S2” electrodes. The “C” and “B” electrodes may be disposed between the “S2” electrodes and the input pads 220 on the another side of the main passageway 210. All of the “S1” electrodes may all be coupled to electrical input 205c and may all be actuated with an actuation voltage being applied to electrical input 205c Likewise, all of the “S2” electrodes may all be coupled to electrical input 205d and may all be actuated with an actuation voltage being applied to electrical input 205d.

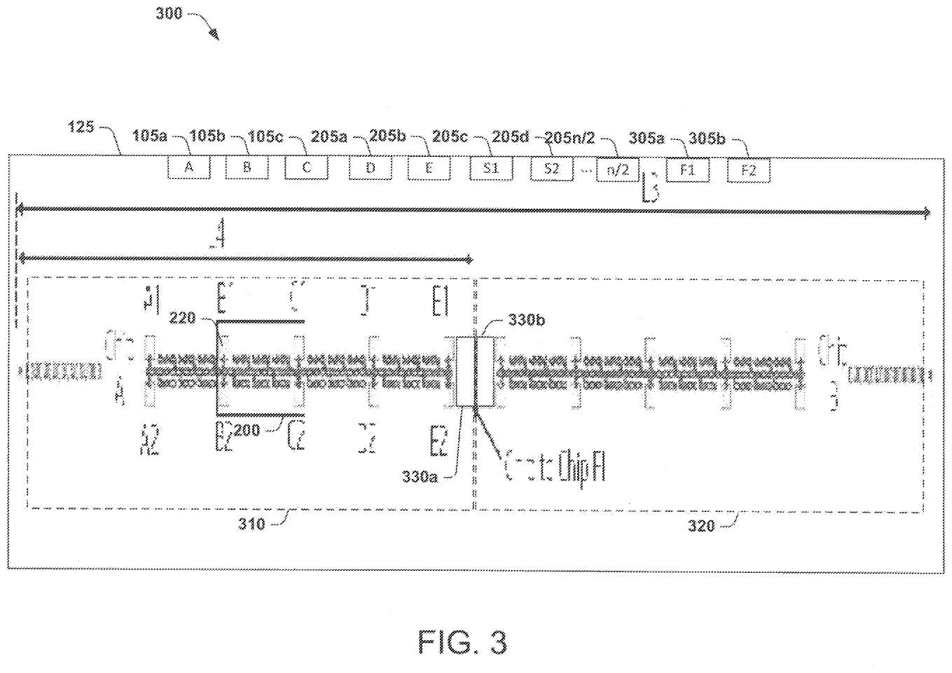

FIG. 3 illustrates yet another example device 300 for manipulating a droplet 120. The device 300 may include the components of device 200, such as the electrical inputs 105/205, the electrodes 110, and the insulator panel 125 (e.g., FR-4 panel). The device 300 may further include repeating copies of the device 200 to form an approximately straight line of repeating devices 200. Thus, the device 300 for manipulation the droplet 120 may include any number of repeating copies of device 200 that are needed to include fluid inputs and droplet manipulation areas within the device. The repeating copies of devices 200 may form chip 310 and another chip 320. Irrespective of the number of copies of the device 200 that are used to create the device 300, the device 300 only needs three electrical inputs 105a-c to actuate electrodes “A”, “B”, and “C” across both of the chips 310 and 320, which minimizes a complexity and size of the device 300.

The device 300 may include chip-to-chip electrodes 330a and 330b. The chip-to-chip electrodes 330a and 330b may be actuated via a corresponding electrical inputs 305a and 305b, respectively. The chip-to-chip electrodes 330a and 330b may move the droplet 120 (or combinations of droplets) between the one chip 310 and the another chip 320. In an example, the chip-to-chip electrodes 330a and 330b may include one or more sensors or actuators to modify to analyze or modify the droplet 120 (e.g., a surface for enhanced Raman spectroscopy (SERS), a heater to perform polymerase chain reaction (PCR), etc.).

In the example shown, the device 300 includes multiple copies of the device 200 to create a length L4. In an example, the length L4 may be approximately 14.35 mm. Each of the chips within the device 300 may have a length L3. In an example, the length L3 may be approximately 28.7 mm.

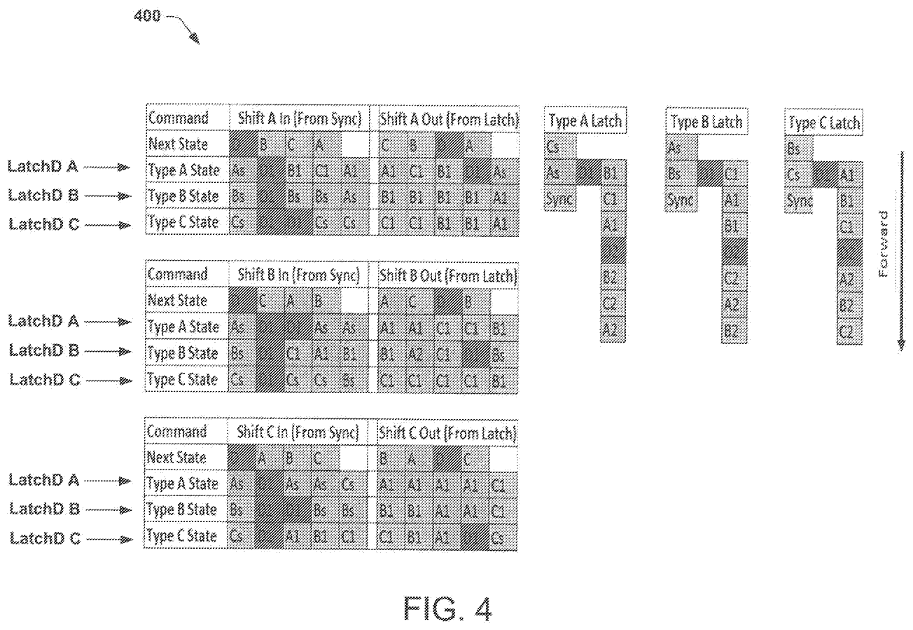

FIG. 4 illustrates an example latch access chart 400 to move a droplet 120 in and out of the latch 230. The latch access chart 400 may be applied to the device 200 shown in FIG. 2. The latch access chart 400 illustrates electrode 110 sequences to move the droplet 120 after the droplet 120 is first moved to a sync position, that is a position adjacent to an “S” sync electrode to setup the electrowetting force. To move the droplet 120 forward, the “A”, “B”, and “C” electrodes may be individually actuated in sequence, and vise versa. For example, to move the droplet 120 in reverse, the “C”, “B”, and “A” electrodes may be individually actuated in sequence. The droplet 120 may be moved via sequencing of the “A”, “B”, and “C” electrodes, and the “C”, “B”, and “A” electrodes until the droplet 120 is next to a desired latch 230. Thereafter, the droplet 120 may be disposed on an “S” sync electrode next to that desired latch 230 once the “S” sync electrode next to that desired latch 230 is actuated with the actuation voltage.

As illustrated, the individual actuation sequence of electrodes 110 to move the droplet 120 into and out of the latches 230 may be dependent on the latch type that the droplet 120 is being moved into and out of. That is, depending if the droplet 120 is being moved into and out of either the “LatchE A”, “LatchE B”, “LatchE C”, “LatchD A”, “LatchD B”, or “LatchD C” latches, the sequence of electrode 110 actuation may differ accordingly. For example, the “LatchE A” latch may include the “A”, “E”, “B” electrode sequence to move the droplet 120 into this latch, the “LatchE B” latch may include the “B”, “E”, “C” electrode sequence to move the droplet 120 into this latch, the “LatchE C” latch may include the “C”, “E”, “A” electrode sequence to move the droplet 120 into this latch, the “LatchD A” latch may include the “A”, “D”, “B” electrode sequence to move the droplet 120 into this latch, the “LatchD B” latch may include the “B”, “D”, “C” electrode sequence to move the droplet 120 into this latch, and the “LatchD C” latch may include the “C”, “D”, “A” electrode sequence to move the droplet 120 into this latch.

To place the droplet 120 next to one of the “S” sync electrodes, the “A”, “B”, and “C” electrodes may be individually actuated in sequence or in reverse sequence, accordingly. The “A”, “B”, and “C” electrodes may be individually actuated in sequence two times with the “S” sync electrodes and “D” electrodes grounded to return a non-latched droplet adjacent to an “S” sync electrode location on the device 200. Such sequencing may not move the droplet 120 once the droplet 120 is positioned next to one of the “S” sync electrodes until the “S” sync electrodes are actuated. Thereafter, the “S” sync electrodes may be actuated to move the droplet 120 onto the “S” sync electrodes and thereafter into the latch 230.

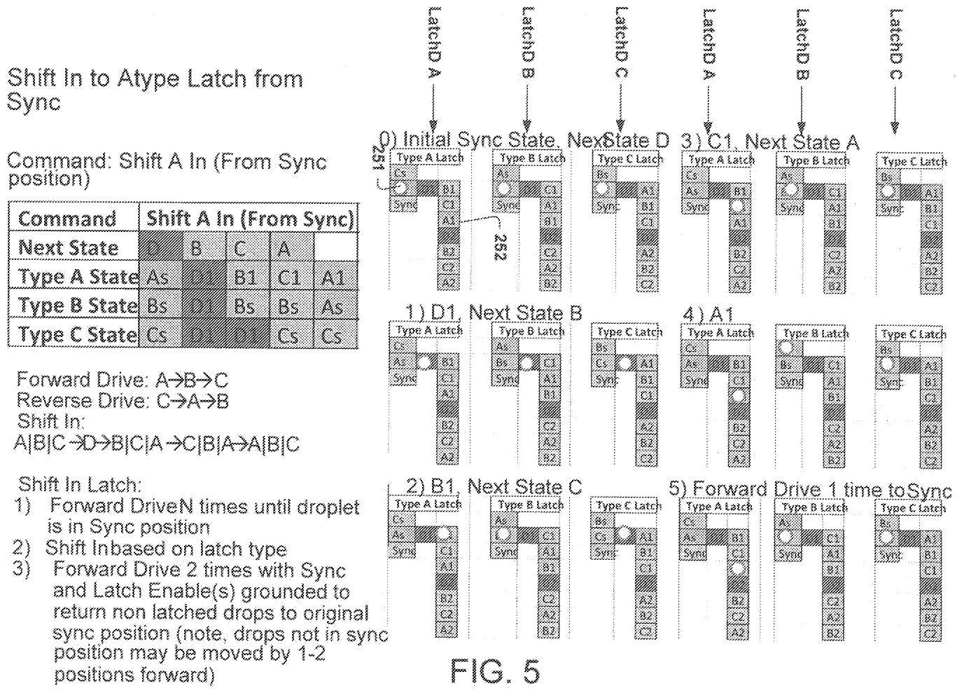

The latch access chart 400 also shows actuation sequences for other electrodes 110 of the device 200 that may be actuated simultaneously while the droplet 120 is being moved into and out of a desired latch 230. Should there be other droplets disposed on the device 200 while the droplet 120 is being moved into and out of a desired latch 230, those other droplets may be moved proximate to a starting position and return to their starting position once the droplet 120 is moved into and out of a desired latch 230. Thus, the other droplets may be prevented from moving into and out of their respective latches while droplet 120 is moved into and out of a desired latch 230. Movement of the other droplets will be explained in more detail in FIG. 5.

FIG. 5 illustrates an example movement of the droplet 120 in and out of the latch 230. FIG. 5 illustrates such movement for a portion of the electrode sequence shown in FIG. 4, namely for the “D”, “B”, “C”, and “A” electrode sequence.

As show in the latch access chart 400 and the example movement of the droplet 120 shown in FIG. 5, to move the droplet 120 from the “A” electrode at position 251 on the main passageway 210 into the “LatchD A” latch to position 252, “As” electrode (i.e., the “A” electrode next to the “S” sync electrode next to position 251) of the “LatchD A” latch, “Dl” electrode (the “1” designation indicating that the “D” electrode is on the “S1” side of the main passageway 210) of the “LatchD A” latch, “B1” electrode of the “LatchD A” latch, “C1” electrode of the “LatchD A” latch, and “A1” electrode the “LatchD A” latch may be individually actuated in sequence. To move the droplet from the ending position 252 out of the “LatchD A” latch back onto the main passageway 210, the reverse sequence of “A1”, “C1”, “B1”, “D1”, and “As” electrodes may be actuated individually in sequence. This sequence of electrode 110 actuation may move the droplet 120 to position 251. The latch access chart 400 likewise also illustrates actuation sequences for moving the droplet 120 into and out of the “LatchD B” and “LatchD C” latches.

During movement of the droplet 120 from position 251 to position 252, electrodes 110 in other latches may be sequentially individually actuated also. For example, the electrodes 110 in the “LatchD B” latch may be sequentially individually actuated as follows while the droplet 120 is being moved into the “LatchD A” latch: “Bs”, “D1”, “Bs”, “Bs”, and “As” . For example, the electrodes 110 in the “LatchD C” latch may be sequentially actuated as follows while the droplet 120 is being moved into the “LatchD A” latch: “Cs”, “D1”, “D1”, “Cs”, and “Cs”. During the movement of the droplet 120 from position 252 to position 251, electrodes 110 in other latches may be sequentially individually actuated also. For example, the electrodes 110 in the “LatchD B” latch may be sequentially individually actuated as follows while the droplet 120 is being moved out of the “LatchD A” latch: “B1”, “B1”, “B1”, “B1”, and “A1”. For example, the electrodes 110 in the “LatchD C” latch may be sequentially individually actuated as follows while the droplet 120 is being moved out of the “LatchD A” latch: “C1”, “C1”, “B1”, “B1”, and “A1”.

For example, should another droplet be positioned at a “B” electrode at position 253 while droplet 120 is positioned at position 251 to be moved into the “LatchD A” latch, that other droplet may return to a same electrode 110 position once droplet 120 has completed its sequence into the “LatchD A” latch. As illustrated in FIG. 5, if another droplet is disposed at position 253 while droplet 120 is positioned at position 251 to be moved into the “LatchD A” latch, the other droplet may move according to a sequence “Bs” (i.e., the “B” electrode next to the “S” sync electrode next to position 253), “Dl” (i.e., “D” electrode closest to position 253), “Bs”, “Bs”, and “As” (i.e., the “A” electrode next to position 253). Thus, the other droplet may be positioned back on the “B” electrode at position 253 once the droplet 120 is fully moved into the “Latch D A” latch according to the “As”, “D1”, “B1”, “C1”, and “A1” sequence. Likewise, the latch access chart 400 shows a latch sequence to move other droplets that are at adjacent the “S” sync electrode nearest the “LatchD C” latch while the droplet 120 is being moved into and out of the “LatchD A” latch.

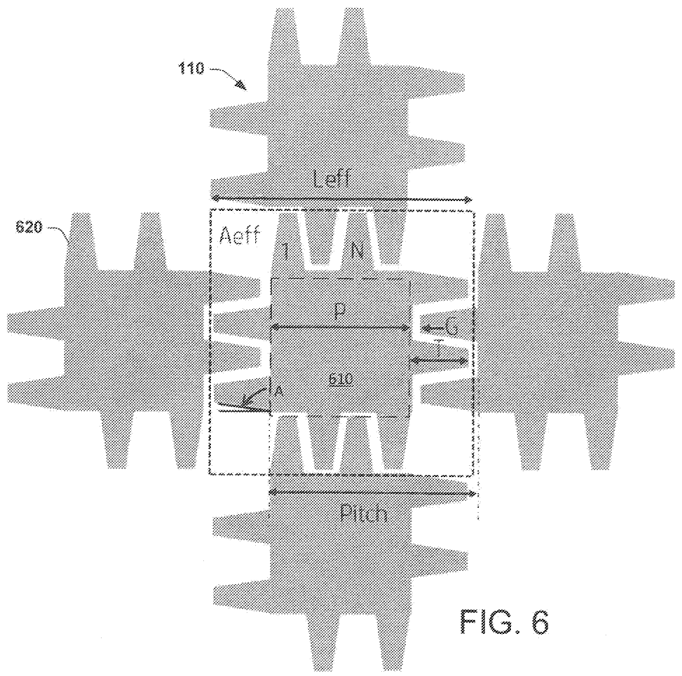

FIG. 6 illustrates a detailed view of the example electrodes 110 that make up the devices 100/200/300. The electrodes 110 may include an approximately square central portion or a pad 610 of length P. In an example, P is 89.5 um. The electrodes 110 may include a number N of teeth 520 on any one side of the pad 610, with the teeth interlocking when disposed on the devices 100/200/300. In an example, N is two (2). In another example, N is greater than two (2). In yet another example, N is one (1). Individual teeth 620 may meet the pad 610 at an angle of A and have a length T. In an example, the angle A is approximately 20 degrees and the length T is approximately 29 um. A gap of dimension G may be disposed between any two of the electrodes 110. In an example, the gap is approximately 1.5 um. An effective area Aeff of the electrodes 110 is (P+2*T+G)². In an example, the Aeff is approximately 150 um. The electrodes 110 may further include a pitch distance that is a function of P+G+T. In an example, pitch is approximately 120 um.

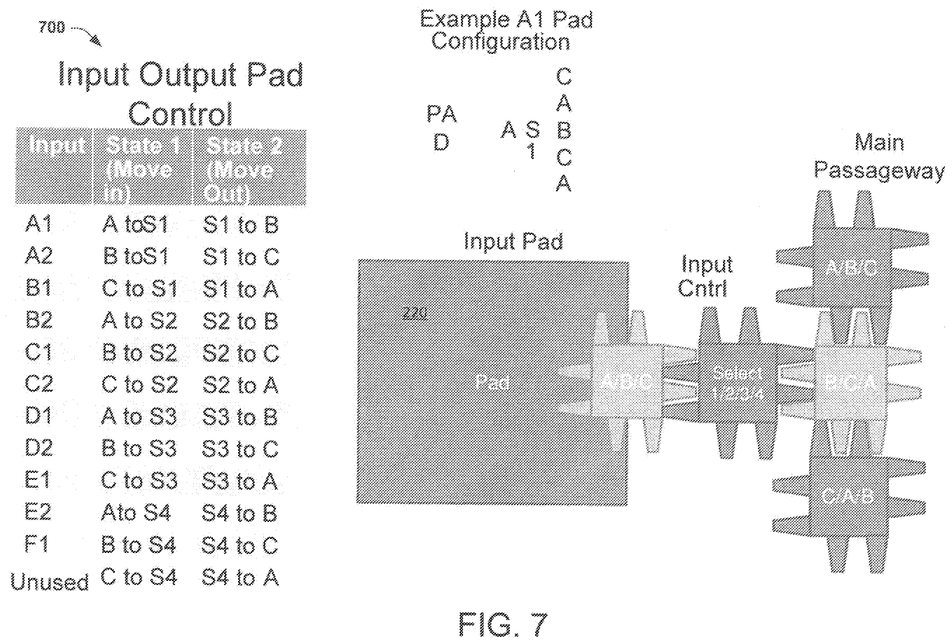

FIG. 7 illustrates an input output pad control chart 700 for the input pads 220 illustrated in FIG. 3. As shown, the input pads 220 may be adjacent either the “A”, “B”, or “C” electrodes. Such “A”, “B”, or “C” electrodes may be adjacent to either the “S1”, “S2”, “S3”, or “S4” select electrodes. Adjacent on another side of the select “S1”, “S2”, “S3”, or “S4” electrodes may be either the “A”, “B”, or “C” electrodes within the main passageway 210 of electrodes 110. On both sides of these “A”, “B”, or “C” electrodes within the main passageway 210 of electrodes 110 are additional “A”, “B”, or “C” electrodes within the main passageway 210 of electrodes 110 to form a repeating sequence of “A”, “B”, and “C” electrodes.

Each of the input pads 220 shown in FIG. 3 may have a unique sequence of electrodes 110 that are actuated to control movement of fluid into and out of the input pads 220. For example, to move fluid into input pad A1, the “A” electrode followed by the “S1” electrode may be actuated. To move fluid out of input pad A1, the “S1” electrode followed by the “B” electrode may be actuated. The input output pad control chart 600 further provides the unique sequence of electrodes 110 that are actuated to control movement of fluid into and out of the A2, B1, B2, C1, C2, D1, D2, E1, E2, and F1 input pads shown in FIG. 3. In an example, the “C” electrode followed by the “S4” electrode sequence may be unused and the “S4” electrode followed by the “A” electrode sequence may be unused.

In view of the foregoing structural and functional features described above, a method in accordance with various aspects of the present disclosure will be better appreciated with reference to FIG. 8. While, for purposes of clarity, the method of FIG. 8 is shown and described as executing serially, it is to be understood and appreciated that the present disclosure is not limited by the illustrated order, as some aspects may, in accordance with the present disclosure, occur in different orders and/or concurrently with other aspects from that shown and described herein. Moreover, not all illustrated features may be required to implement a method in accordance with an aspect of the present disclosure.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims.

The preceding description has been presented to illustrate and describe examples of the principles described. This description is not intended to be exhaustive or to limit these principles to any precise form disclosed. Many modifications and variations are possible in light of the above teaching. What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A device, comprising:
an insulator panel;
a plurality of electrical inputs, disposed on the insulator panel, that individually receive an actuation voltage; and
a plurality of electrodes, disposed on the insulator panel, coupled to the plurality of electrical inputs wherein two or more of the plurality of electrodes are coupled to a single one of the plurality of electrical inputs for each of the plurality of electrical inputs, the plurality of electrodes being actuated with the actuation voltage individually received at a respective electrical input to create an electric field over associated electrodes to subject a droplet proximate to the associated electrodes actuated with the actuation voltage to an electrowetting force.

2. The device of claim 1, wherein the plurality of electrodes are a first plurality of electrodes and the droplet is a first droplet, the device further comprising a latch comprising a second plurality of electrodes that branches off of the first plurality of electrodes, the second plurality of electrodes providing an area in which the first droplet is combined with the second droplet to mix components of the first and second droplets.

3. The device of claim 2, further comprising a gatekeeper electrode at an entry into the latch, the gatekeeper electrode coupled to a particular electrical input and actuated to allow the droplet to enter the latch.

4. The device of claim 1, wherein the plurality of electrodes include a repeating sequence of three or more electrodes comprised of “A”, “B”, and “C” electrodes, the “A” electrodes coupled to a first electrical input from the plurality of electrical inputs, the “B” electrodes coupled to a second electrical input from the plurality of electrical inputs, and the “C” electrodes coupled to a third electrical input from the plurality of electrical inputs.

5. The device of claim 1, further comprising a fluid processing chip disposed proximate to a given electrode from the plurality of electrodes, wherein the given electrode from the plurality of electrodes is actuated to move the droplet with the electrowetting force to the fluid processing chip to analyze the droplet.

6. The device of claim 1, wherein the plurality of electrodes are a first plurality of electrodes, the device further comprising a plurality of sync electrodes coupled to a given electrical input and controlling passage of the droplet from the first plurality of electrodes of the device to a second plurality of electrodes of the device.

7. The device of claim 1, wherein the plurality of electrodes are disposed in approximately a straight line to move the droplet from a first end of the straight line to a second end of the straight line.

8. The device of claim 1, wherein the electrowetting force subjects the droplet to one or more of merging with another droplet, splitting the droplet into two droplets, and moving the droplet to another electrode.

9. The device of claim 1, wherein each of the plurality of electrodes includes one or more teeth on each side of the plurality of electrodes.

10. A device, comprising:
a main passageway comprising a first plurality of a repeating sequence of electrodes;
a first latch comprised of a second plurality of the repeating sequence of electrodes that branch off of the first plurality of the repeating sequence of electrodes; and
a second latch comprised of a third plurality of the repeating sequence of electrodes that branch off of the first plurality of the repeating sequence of electrodes, the third plurality of the repeating sequence of electrodes being offset with respect to the second plurality of the repeating sequence of electrodes such that actuation of the second plurality of the repeating sequence of electrodes moves a first droplet into the first latch and actuation of the third plurality of the repeating sequence of electrodes prevents a second droplet from moving into the second latch;
wherein two or more electrodes from each of the first, second, and third plurality of the repeating sequence of electrodes are coupled to a single one of the plurality of electrical inputs for each of the plurality of electrical inputs.

11. The device of claim 10, further comprising a third latch comprising a fourth plurality of the repeating sequence of electrodes that branch off the first plurality of the repeating sequence of electrodes, the fourth plurality of the repeating sequence of electrodes being offset with respect to the first and second plurality of the repeating sequence of electrodes such that actuation of the fourth plurality of the repeating sequence of electrodes prevents a third droplet from moving into the third latch.

12. The device of claim 10, further comprising first and second gatekeeper electrodes at an entry into the first and second latch, respectively, the first and gatekeeper electrodes coupled to a particular electrical input and actuated to allow the droplet to enter the first latch.

13. The device of claim 10, wherein the repeating sequence of electrodes include a repeating sequence of three or more electrodes comprised of “A”, “B”, and “C” electrodes, the “A” electrodes coupled to a first electrical input from the plurality of electrical inputs, the “B” electrodes coupled to a second electrical input from the plurality of electrical inputs, and the “C” electrodes coupled to a third electrical input from the plurality of electrical inputs.

14. The device of claim 10, further comprising a fluid processing chip disposed proximate to a given electrode from the first plurality of the repeating sequence of electrodes, wherein the given electrode from the plurality of electrodes is actuated to move the droplet to the fluid processing chip to analyze the droplet.

15. The device of claim 10, wherein the main passageway further comprises a plurality of sync electrodes coupled to a given electrical input and controlling passage of the first and second droplet from a first portion of the main passageway to a second portion of the main passageway.
